(19) United States
(12) Patent Application Publication
(10) Pub. No.: US 2004/0076518 A1
(43) Pub. Date: Apr. 22, 2004

(54) Tilt stabilized / ballast controlled wind turbine

(76) Inventor: Devon Glen Drake, Morgantown, WV (US)

Correspondence Address: Devon G. Drake, PO Box 691, Reedsville, WV, 26547, US

(21) Appl. No.: 10/271,982

(22) Filed: Oct. 17, 2002

(51) Int. Cl. F03D 7/04

(52) U.S. Cl. 416/10; 416/117; 416/148

(57) ABSTRACT

This invention pertains to a horizontal axis wind turbine of down-wind design that tilts rather than teetering to overcome loads produced by gyroscopic precession. Gyroscopic precession occurs to the rotor as it is spinning when it turns to adjust to or follow a wind directional change. It is absolutely necessary to provide a means by which to overcome this phenomena as it can lead to structural failures due to it's extreme effects. Wind turbines that can not overcome these effects usually have an active yaw system that will turn them very slowly in order to not encounter the effects of the extreme loads produced by gyroscopic precession. This invention also provides a means by which to control the rotor speed based upon the using of the turbine's own weight as a basis for that control. These two functions work in unison and are immediate in their response to provide for a superior dynamic wind turbine design that will be more cost effective to produce as well as maintain. It also provides for very stable and reliable operation.

### BACKGROUND OF THE INVENTION

This invention relates to a wind turbine that is designed to overcome loads produced by gyroscopic precession. It also provides for a new method of rotor speed control which uses the weight of the turbine itself as a ballast and regulator for that control.

Unlike the teetering-type, 2-bladed, downwind, horizontal axis wind turbines in common use, this wind turbine utilizes a tilt-type system which allows the rotor to be turned or yawed out of the wind at any time especially during an emergency such as a runaway situation in high winds. It is uncommon if not impossible for teetering-type wind turbines to be yawed out of the wind in high winds without being destroyed or while they retain the ability to overcome extreme loads from gyroscopic precession.

This tilt system enables the 2-bladed downwind precession compensating turbine to be yawed out of the wind on a regular basis as a common operational characteristic. As no yaw control is necessary to position the rotor in the wind, costs associated with wear and tear would be minimal in comparison to conventional upwind-type wind turbines that utilize a yaw control system to continually position their rotor in the wind. The yaw system would only engage to be used for shutdowns. This also has the advantage of reducing extreme loads throughout the drive train as brakes need only be applied in the event of failure of the “shutdown yaw system”. Brakes therefore would rarely if ever need to be used other than for a backup system or as a “parking brake”. Overall dependability and reduction of maintenance and repair costs of the drive-train, brake system, and yaw system are considerably improved upon with this tilt-type wind turbine.

Another improvement includes the elimination of certain unstable characteristics produced by teetering-type turbines in that they will produce a gyration between the yaw axis plane and the teeter axis plane as they come into parallel position or alignment in relation to one another with each ½ cycle of rotation of the rotor. This “double plane” effect is exactly what led to the destruction of many 2-bladed, downwind, teetering, wind turbines and is still a misunderstood and unidentified problem with these turbines especially those that are basically centered upon their yaw bearing with respect to weight distribution. This tilt-type system eliminates teetering completely and this flaw associated with it.

Of particular importance is the ability to use 2 blades, in that 2 blades are cheaper and lighter than the 3 which are now most commonly used. 2 blades are also much easier to balance and as is commonly known will out-produce 3.

Since a free yaw system can be used, the rotor is almost always perfectly in balance with all wind pressures and forces of gyroscopic precession applied to it. This is the optimum achievable rotor performance.

### BACKGROUND OF THE INVENTION CONTINUED

This tilt-type system retains the advantages associated with the teetering-type wind turbines while it eliminates the disadvantages thereof. It should also be kept in mind that this system can be applied to wind turbines using any number of blades on their rotor. Most any downwind turbine could be modified for improvement with the tilt design to eliminate extreme loads produced by gyroscopic precession.

### SUMMARY OF THE INVENTION

Unlike wind turbines that utilize a teetering rotor to overcome loads produced by gyroscopic precession, this wind turbine uses a tilt system in which the entire mainframe-rotor assembly tilts to overcome the loads that would otherwise be produced by gyroscopic precession as the rotor yaws to follow wind directional changes. It also utilizes it's own weight as a ballast to control the rotor's speed. Both of these functions operate independent of each other while using the same two pivot axis' for movement. The mainframe and rotor assembly is suspended with a basically horizontal center of gravity below these two pivot axis' which are connected to a support structure mounted upon the yaw system.

### BRIEF DESCRIPTION OF THE DRAWINGS

FIG. 1 is a side view of the wind turbine showing it in the idle position as when there is no wind. the blades are pitched to the optimum lift position for low winds and the mainframe-rotor assembly is seen centered, level and horizontal,

FIG. 2 is a side view showing the wind turbine as it would be seen in high winds. The blades are pitched to the least lift position and the mainframe-rotor assembly is level and horizontal.

FIG. 3 is a side view of the wind turbine showing it tilting downward to compensate for gyroscopic precession as when it would turn to follow a wind direction change in a particular direction. The wind turbine is also shown as it would be seen in a medium wind speed. “Stops” or “limits” which prevent the unit from tilting too far downward are not shown in this drawing. These and a damper shock are shown as options in FIGS. 8 and 9.

FIG. 4 is a side view of the wind turbine showing it tilting upward in the opposite direction as that shown in FIG. 3.

FIG. 5 is a frontal view of the wind turbine showing the “U” shaped support structure.

FIG. 6 is a side view showing the basic movements for ballast control.

FIG. 7 is a side view showing the basic movements for tilt stabilization.

FIG. 8 is a side view showing optional stops, roller, and guide positions.

FIG. 9 is a side view showing the position of the optional damper shock.

### DETAILED DESCRIPTION OF THE INVENTION

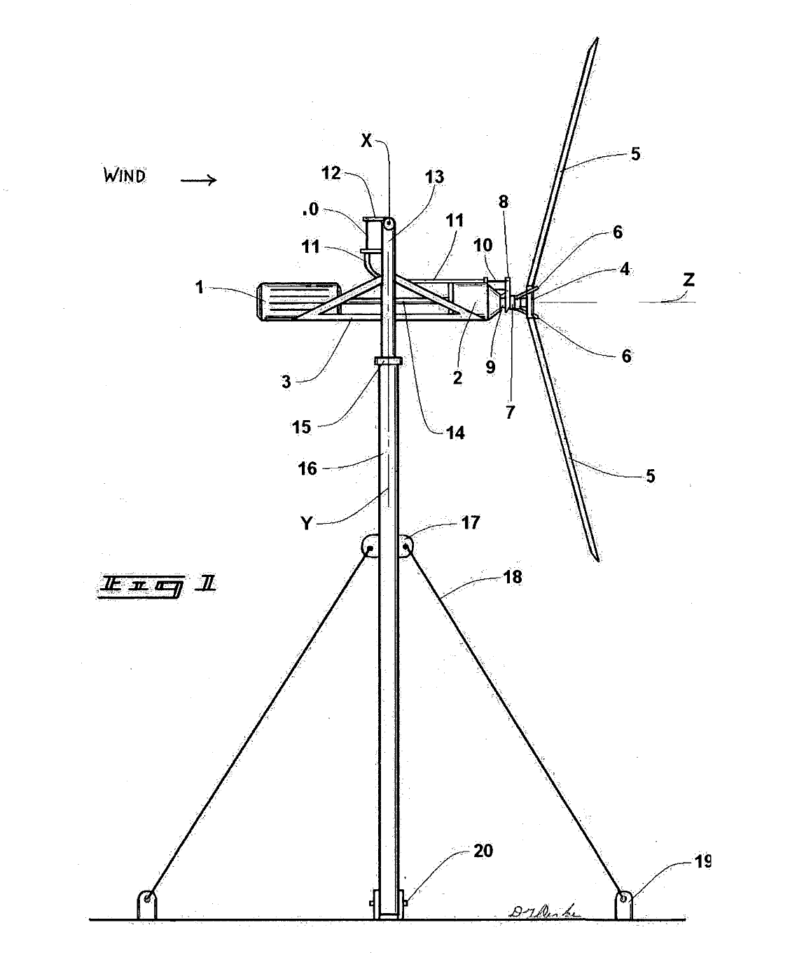

FIG. 1 shows a side view of a wind turbine having two rotor blades 5 which are swept back or coned away from the rotor hub 4 in the downwind direction. The rotor hub 4 is attached to the end of the main or low speed shaft 9 of the transmission 2. The rotor blades 5 are shown pitched in the low wind position for optimum lift. A demonstrative general pitch control system consisting of ball joint rods 6, slide actuator 7, and control lever 8 are operated through the use of a pull cable 10 encased within a guide tube 11. One end of the pull cable 10 is connected to a guide arm 12 with the other end connected to the control lever 8. The entire mainframe/rotor assembly consists primarily of the rotor blades 5, hub 4, transmission 2, generator 1, and mainframe 3. The mainframe/rotor assembly is suspended from the X and W axis' bearings with the W axis bearing being perpendicular to and below the X axis bearing being connected by a swing arm 21 which can not be seen in this view. The W axis bearing also is not seen in this view. The X axis bearing is connected to the top of a support structure 13 which revolves around the Y axis upon the yaw bearing 15. The yaw bearing 15 is mounted to the top of a pole tower 16 which hinges 20 at the base for lowering and raising. The pole tower 16 is supported by guy cables 18 and connections 17 and 19. The high speed shaft 14 of the transmission 2 connects to the generator 1. The mainframe/rotor assembly is shown oriented in the centered and balanced/horizontal position of operation as it would appear in minimal winds.

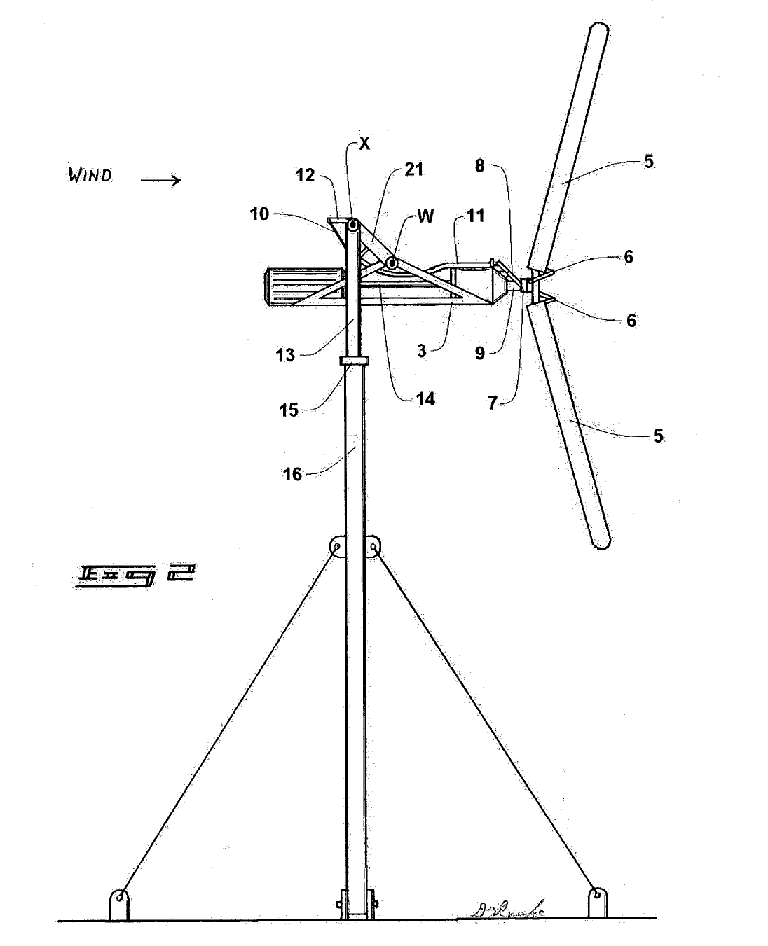

FIG. 2 As the wind speed increases the mainframe/rotor assembly gradually move rearward or downwind rotating upon the X and W axis' until the maximum blade pitch angle of lift reduction is achieved as shown here. The turbine is seen in this position in high winds. The turbine will operate between this maximum angle and the minimum angle as shown in FIG. 1. The X and W axis' can be seen connected by a swing-arm 21.

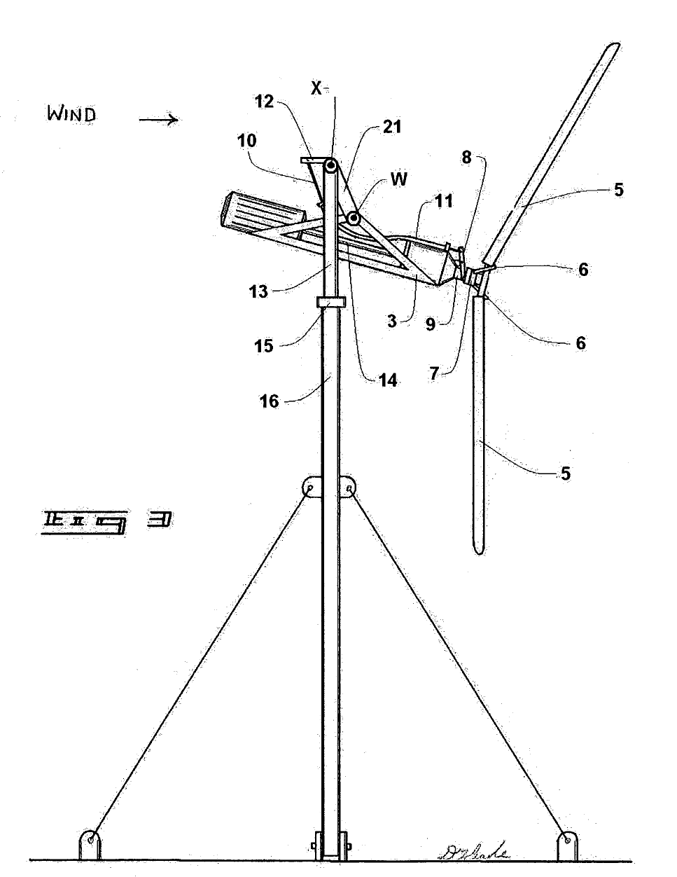

FIG. 3 shows the normal downward tilt of the mainframe/rotor assembly upon the W axis in response to effects of gyroscopic precession produced upon the rotor as the turbine yaws or turns to follow a wind direction change in a particular direction. As the turbine stops yawing the mainframe/rotor assembly will return to the balanced or horizontal position as shown in FIGS. 1 and 2.

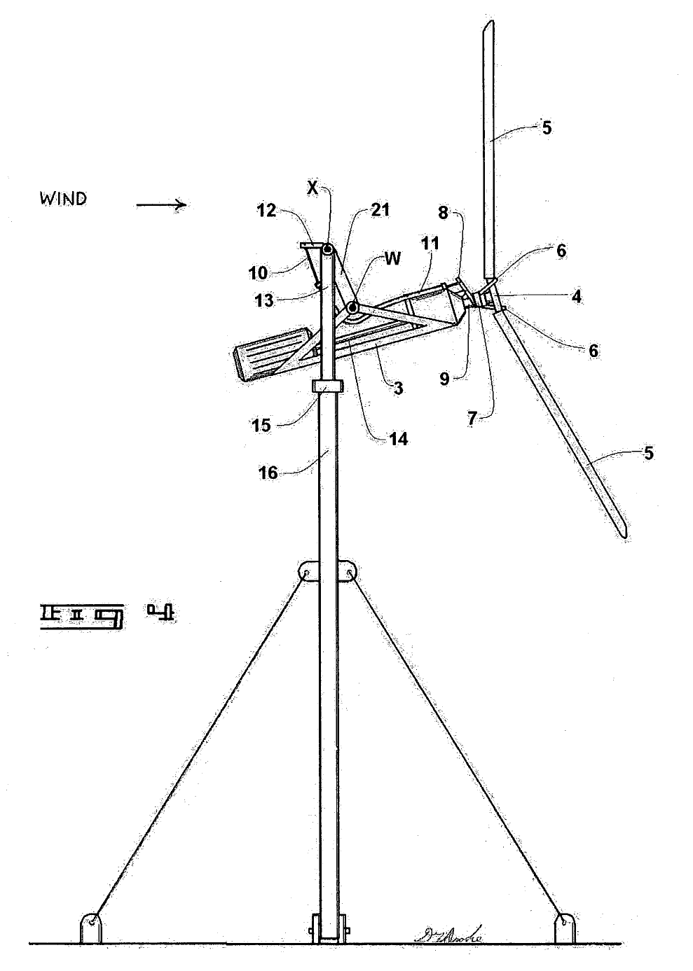

FIG. 4 shows the normal upward tilt of the mainframe/rotor assembly upon the W axis in response to the gyroscopic precession produced upon the rotor as the turbine yaws or turns to follow a wind direction change in the opposite direction as that shown in FIG. 3. As the turbine stops yawing the mainframe/rotor assembly will return to the balanced or horizontal position as shown in FIGS. 1 and 2.

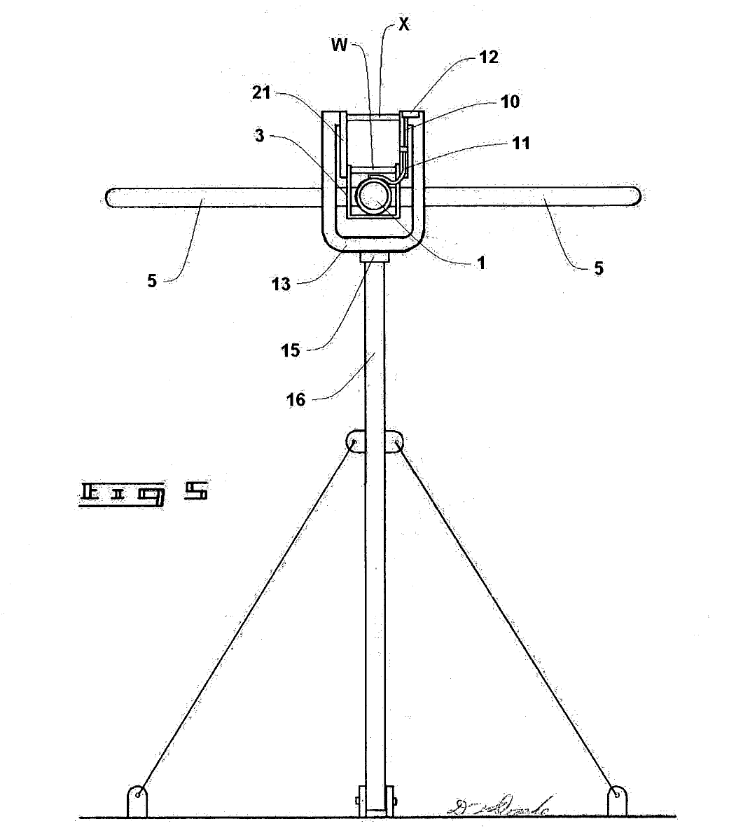

FIG. 5 is a frontal view of the turbine with the blades 5 shown in the horizontal position and the mainframe/rotor assembly shown suspended from a “U” shaped support structure 13 having two upright connection arms 21 from which the X axis is connected between. The W axis is connected to and below the X axis. The mainframe/rotor assembly is connected to and below the W axis.

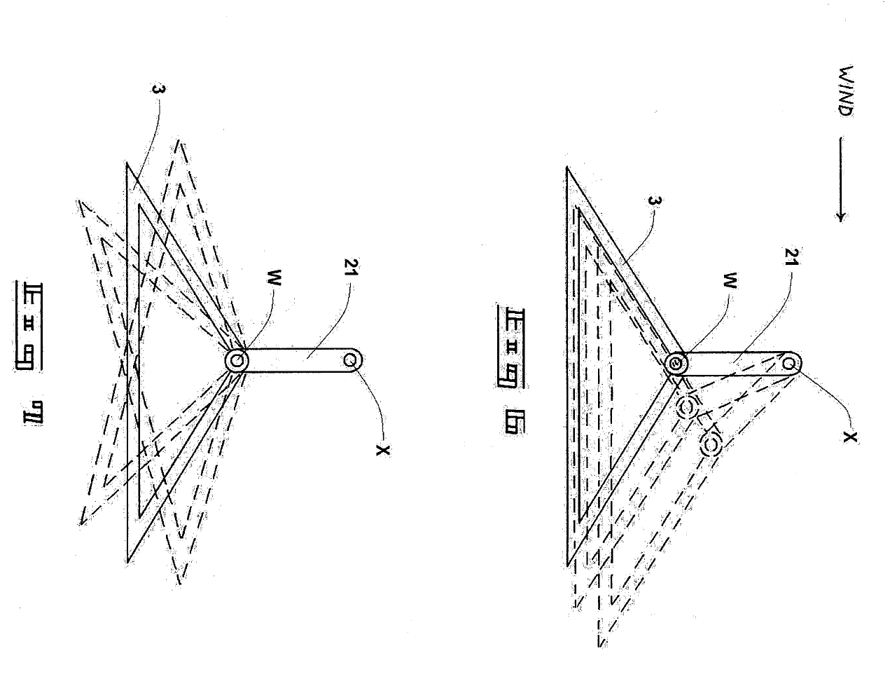

FIG. 6 shows the basic movement of the mainframe 3 for ballast control.

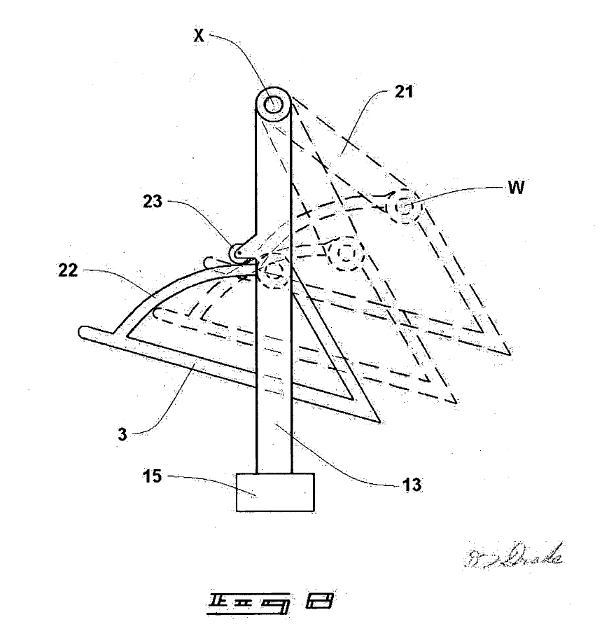

FIG. 7 shows the basic movement of the mainframe 3 for tilt stabilization.

### DETAILED DESCRIPTION OF THE INVENTION (CONTINUED)

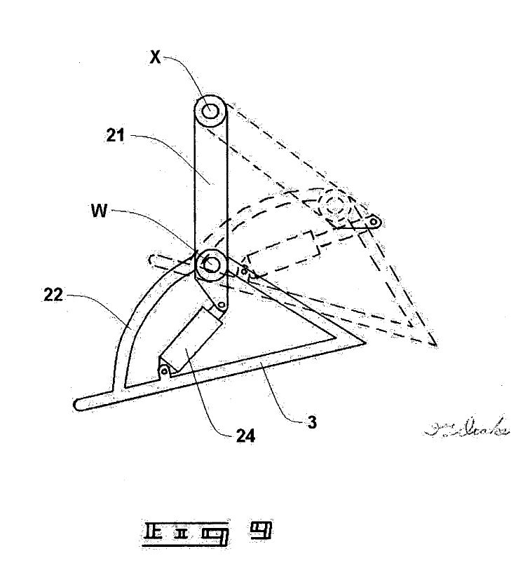

FIG. 8 is a partial view showing one of many ways that the mainframe 3 angle can be controlled to prevent the blades 5 from striking the tower 16 as the mainframe/rotor assembly tilts downward in response to induced gyroscopic precession as shown in FIG. 3. In this instance the mainframe 3 has been modified with a curved guide 22 which contacts a roller 23 to limit the degree of angle by which the mainframe/rotor assembly tilts downward. This maximum angle remains constant regardless of the angle of the swing-arm 21 which continually changes it's angle according to the wind speed.

FIG. 9 is a partial view showing one of several ways that the movements of the tilt stabilization and ballast control can be dampened. This may be desirable to achieve superior performance. The damper shock 24 is shown connected to an extended swing-arm 21 and the mainframe 3. This mainframe 3 is the example shown in FIG. 8 having the curved guide 22.

What is claimed is that:

1. Using any number of rotor blades the wind turbine mainframe and rotor as a unit are suspended and balanced with a generally horizontal or level center of gravity from and below two parallel swing-arm connected horizontal pivot axis' positioned perpendicular to the rotor's axis of rotation with one said pivot axis positioned above, being the upper pivot axis, which is mounted to the top of a support structure that rotates about a vertical axis upon a generally free-yaw bearing member that allows the mainframe-rotor assembly to follow wind directional changes, and the other said pivot axis is positioned below, being the lower pivot axis, to which the said mainframe-rotor assembly is connected to and suspended from.

2. The wind turbine mainframe-rotor assembly, dependent upon counter-clockwise or clockwise yaw rotation, will tilt either up or down from level or generally horizontal being counterbalanced to return to level or generally horizontal upon a pivot point perpendicular to the said mainframe-rotor assembly's axis of rotation in order to compensate for the gyroscopic precession which is produced during yaw rotation while following wind directional changes.

3. The wind turbine mainframe-rotor assembly as defined in claim 1 provides for gyroscopic precession compensation to occur as well as a means by which to control and regulate any type of rotor speed control systems such as blade pitching, tip deployment, ailerons, flaps, etc., with said upper and lower pivot axis' working in unison to facilitate both gyroscopic precession compensation and rotor speed control.

4. The wind turbine mainframe-rotor assembly as defined in claim 1 will hang centered and gradually move rearward and up against it's own weight acting as a ballast to regulate or activate any type of rotor speed control system to reduce rotor performance as the wind speed increases by rotating upon the said upper pivot axis while remaining generally horizontal or level by rotating upon the said lower pivot axis according to the center of gravity or any degree of tilt induced by gyroscopic precession.

5. The wind turbine mainframe-rotor assembly is provided with stops, limits, or guides to regulate the amount of angle that the said mainframe-rotor assembly will tilt downward during compensation for gyroscopic precession so as to prevent the rotor blades from coming in contact with or striking the tower.
